(19) United States
(12) Patent Application Publication
(10) Pub. No.: US 2019/0241169 A1
(43) Pub. Date: Aug. 8, 2019

(54) Assembly of Screws for a Screw Compressor for a Utility Vehicle

(71) Applicant: KNORR-BREMSE SYSTEME FUER NUTZFAHRZEUGE GMBH, Muenchen (DE)

(72) Inventors: Gilles HEBRARD, Muenchen (DE); Jean-Baptiste MARESCOT, Muenchen (DE); Joerg MELLAR, Muenchen (DE); Thomas WEINHOLD, Muenchen (DE)

(21) Appl. No.: 16/331,271

(22) PCT Filed: Sep. 19, 2017
(86) PCT No.: PCT/EP2017/073541

§ 371 Date: Apr. 17, 2019

(30) Foreign Application Priority Data
Sep. 21, 2016 (DE) 10 2016 011 436.3

(51) Int. Cl. B60T 17/02; F04C 18/16; F04C 18/20

(52) U.S. Cl. CPC B60T 17/02; F01C 21/08; F04C 18/20; F04C 18/16

(57) ABSTRACT

An arrangement of screws for a screw compressor for a utility vehicle includes at least one female screw and at least one male screw. The female screw and the male screw each have teeth that engage with one another. The teeth of the female screw have a roll-off tooth flank which is provided for rolling-off a tooth flank of the male screw. The roll-off tooth flank has a convexly rounded roll-off tip region in the tip region, which has a first radius, wherein a tooth base is provided between two neighboring teeth of the female screw, which is connected to the roll-off tip region via a flat transition region. The tooth base between two teeth of the female screw is substantially concavely rounded and has a second radius, wherein the second radius is approx. 2.5 to 3.5 times greater than the first radius.

### BACKGROUND AND SUMMARY OF THE INVENTION

The present invention relates to an arrangement of screws for a screw compressor for a utility vehicle, having at least one female screw and at least one male screw.

Screw compressors for utility vehicles are already known from the prior art. Such screw compressors are used to provide the compressed air required for the brake system of the utility vehicle, for example.

In this context, in particular oil-filled compressors, in particular also screw compressors, are known, in the case of which it is necessary to regulate the oil temperature. This is generally realized by virtue of an external oil cooler being provided which is connected to the oil-filled compressor and to the oil circuit via a thermostat valve. Here, the oil cooler is a heat exchanger which has two mutually separate circuits, wherein the first circuit is provided for the hot liquid, that is to say the compressor oil, and the second circuit is provided for the cooling liquid. As cooling liquid, use may for example be made of air, water mixtures with an antifreeze, or another oil.

This oil cooler must then be connected to the compressor oil circuit by means of pipes or hoses, and the oil circuit must be safeguarded against leakages.

This external volume must furthermore be filled with oil, such that the total quantity of oil is also increased. The system inertia is thus increased. Furthermore, the oil cooler must be mechanically accommodated and fastened, either by means of brackets situated in the surroundings or by means of a separate bracket, which necessitates additional fastening means and also structural space.

It is the object of the present invention to develop the design of intermeshing screws of a screw compressor such that the compression power of a screw compressor can be improved.

This object is achieved according to the invention by an arrangement of screws for a screw compressor for a utility vehicle, having at least one female screw and at least one male screw, wherein the female screw and the male screw each have teeth which mesh with one another, and wherein the teeth of the female screw have a rolling tooth flank which is provided for rolling on a tooth flank of the male screw. The rolling tooth flank has, in the tip region, a convexly rounded rolling tip region which has a first radius, wherein, between two adjacent teeth of the female screw, there is provided a tooth base which is connected via a flat transition region to the rolling tip region. The tooth base between two teeth of the female screw is substantially concavely rounded with at least a second radius, wherein the second radius is approximately 2.5 to 3.5 times greater than the first radius.

The invention is based on the underlying concept of ensuring, by means of the design of the tip region of the female screw which meshes with the male screw teeth, that at the moment of maximum engagement of the teeth with one another, a reliable sealing action is realized between the two screw rotors and, in this way, an advancement of the fluid to be compressed, in particular compressed air, can be realized. By means of such a design, it is furthermore sought to improve the wettability of the surfaces of the teeth and also of the screw rotors or screws with oil.

In particular, provision may be made for the number of teeth of the female screw to be greater than that of the male screw. In this way, it is made possible for the ratio of the rotational speeds of the female screw and of the male screw to be able to be set correspondingly to one another.

Furthermore, provision may be made for the transmission ratio of female screw to male screw to be 3:2. It is thus made possible for the speed ratios to likewise be able to be set in the ratio 3:2.

Here, the female screw may have 6 teeth and the male screw may have 4 teeth. In this way, it is made possible to realize a relatively simple design and a highly effective transmission ratio. Simple production is possible, and relatively quiet operation with high compressor power can be achieved.

The female screw and the male screw may have substantially the same nominal diameter. In this way, the meshing of the male screw and of the female screw with one another is simplified. Furthermore, the mounting of the screws in the housing of the screw compressor is also improved in this way.

Provision may furthermore be made whereby the teeth of the female screw have, on the side averted from the rolling tooth flank, a setting-down flank for the setting-down onto the teeth of the male screw, wherein the setting-down flank transitions from the rolling tip region by means of a tip region with a third radius which is smaller than the first radius, in particular approximately 2.5 times to 3.5 times smaller than the first radius. It is achieved in this way that that region in the tip of the teeth of the female screw which protrudes into the deepest point of the tooth base of the male screw is designed with the smallest possible radius, but at the same time the rolling movement of the tip of the female screw teeth into the tooth base of the male screw can take place not abruptly but with a relatively uniform transition. At the same time, through the selection of the third radius, the contact line of the tip of the female tooth with the deepest region of the tooth base of the male teeth of the male screw is also determined, wherein the selection of a relatively small radius in this case greatly improves the sealing action.

The tip region may transition directly, without an intermediate region, into the tooth base of the female screw. It is not necessary here to provide a transition region, because the tooth flank merely has to bear with sealing action against the corresponding counterpart flank of the male screw, but does not roll on said counterpart flank during drive and meshing situations.

Provision may furthermore be made for the teeth of the female screw to be formed in the manner of turbine blades. This design with relatively slim teeth on the female screw makes it possible for the teeth of the female screw to be of relatively elastic form owing to the design, and to thus be able to engage sealingly into the tooth intermediate spaces and tooth bases of the male screw.

The teeth of the male screw may have a tooth base, at the lowest point of which there is provided a rounded kink, wherein the lowest point of the kink is provided for the engagement with the rolling tip region and the tip region. By means of this kinked form, the sealing action between the teeth of the female screw and of the male screw is likewise improved.

Provision may be made in particular for the kink to substantially enclose an angle between approximately 90° and approximately 110°. A kink of such form likewise promotes the formation of a contact line with good sealing action at the moment of engagement of the tip region of the female teeth into the lowest point of the tooth base, that is to say the kink of the male screw.

Further details and advantages of the invention will now be discussed on the basis of an exemplary embodiment illustrated in more detail in the drawings.

### BRIEF DESCRIPTION OF THE DRAWINGS

FIG. 1 shows a schematic sectional drawing through a screw compressor according to the invention; and

FIG. 2 shows a schematic frontal view of the intermeshing male and female screws of the screw compressor.

### DETAILED DESCRIPTION OF THE DRAWINGS

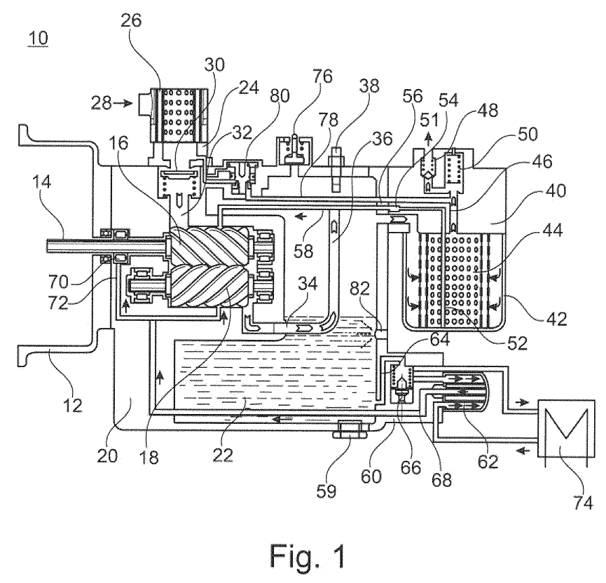

FIG. 1 shows, in a schematic sectional illustration, a screw compressor 10 in the context of an exemplary embodiment of the present invention.

The screw compressor 10 has a fastening flange 12 for the mechanical fastening of the screw compressor 10 to an electric motor (not shown in any more detail here).

What is shown, however, is the input shaft 14, by which the torque from the electric motor is transmitted to one of the two screws 16 and 18, specifically the screw 16.

The screw 18 meshes with the screw 16 and is driven by means of the latter.

The screw compressor 10 has a housing 20 in which the main components of the screw compressor 10 are accommodated.

The housing 20 is filled with oil 22.

At the air inlet side, an inlet connector 24 is provided on the housing 20 of the screw compressor 10. The inlet connector 24 is in this case designed such that an air filter 26 is arranged at said inlet connector. Furthermore, an air inlet 28 is provided radially on the air inlet connector 24.

In the region between the inlet connector 24 and the point at which the inlet connector 24 joins to the housing 20, there is provided a spring-loaded valve insert 30, which is designed here as an axial seal.

The valve insert 30 serves as a check valve.

Downstream of the valve insert 30, there is provided an air feed channel 32 which feeds the air to the two screws 16, 18.

At the outlet side of the two screws 16, 18, there is provided an air outlet pipe 34 with a riser line 36.

In the region of the end of the riser line 36, there is provided a temperature sensor 38 by which the oil temperature can be monitored.

Also provided in the air outlet region is a holder 40 for an air deoiling element 42.

In the assembled state, the holder 40 for the air deoiling element has the air deoiling element 42 in the region facing toward the base (as also shown in FIG. 1).

Also provided, in the interior of the air deoiling element 42, is a corresponding filter screen or known filter and oil separation devices 44, which will not be specified in any more detail.

In the central upper region in relation to the assembled and operationally ready state (that is to say as shown in FIG. 1), the holder for the air deoiling element 42 has an air outlet opening 46 which leads to a check valve 48 and a minimum pressure valve 50. The check valve 48 and the minimum pressure valve 50 may also be formed in one common combined valve.

The air outlet 51 is provided downstream of the check valve 48.

The air outlet 51 is generally connected to correspondingly known compressed-air consumers.

In order for the oil 22 that is situated and separated off in the air deoiling element 42 to be returned into the housing 20, a riser line 52 is provided which has a filter and check valve 54 at the outlet of the holder 40 for the air deoiling element 42 at the transition into the housing 20.

A nozzle 56 is provided, downstream of the filter and check valve 54, in a housing bore. The oil return line 58 leads back into approximately the central region of the screw 16 or of the screw 18 in order to feed oil 22 thereto again.

An oil drain screw 59 is provided in the base region, in the assembled state, of the housing 20. By means of the oil drain screw 59, a corresponding oil outflow opening can be opened, via which the oil 22 can be drained.

Also provided in the lower region of the housing 20 is the attachment piece 60 to which the oil filter 62 is fastened. Via an oil filter inlet channel 64, which is arranged in the housing 20, the oil 22 is conducted firstly to a thermostat valve 66.

Instead of the thermostat valve 66, it is possible for an open-loop and/or closed-loop control device to be provided by which the oil temperature of the oil 22 situated in the housing 20 can be monitored and set to a setpoint value.

Downstream of the thermostat valve 66, there is then the oil inlet of the oil filter 62, which, via a central return line 68, conducts the oil 22 back to the screw 18 or to the screw 16 again, and also to the oil-lubricated bearing 70 of the shaft 14. Also provided in the region of the bearing 70 is a nozzle 72, which is provided in the housing 20 in conjunction with the return line 68.

The cooler 74 is connected to the attachment piece 60.

In the upper region of the housing 20 (in relation to the assembled state), there is situated a safety valve 76, by which an excessively high pressure in the housing 20 can be dissipated.

Upstream of the minimum pressure valve 50, there is situated a bypass line 78, which leads to a relief valve 80. Via the relief valve 80, which is activated by a connection to the air feed 32, air can be returned into the region of the air inlet 28. In this region, there may be provided a ventilation valve (not shown in any more detail) and also a nozzle (diameter constriction of the feeding line).

Furthermore, approximately at the level of the line 34, an oil level sensor 82 may be provided in the outer wall of the housing 20. The oil level sensor 82 may for example be an optical sensor, and may be designed and configured such that, on the basis of the sensor signal, it can be identified whether the oil level during operation is above the oil level sensor 82 or whether the oil level sensor 82 is exposed, and thus the oil level has correspondingly fallen.

In conjunction with this monitoring, it is also possible for an alarm unit to be provided which outputs or transmits a corresponding error message or fault message to the user of the system.

The function of the screw compressor 10 shown in FIG. 1 is as follows.

Air is fed via the air inlet 28 and passes via the check valve 30 to the screws 16, 18, where the air is compressed. The compressed air-oil mixture, which, having been compressed by a factor of between 5 and 16 downstream of the screws 16 and 18, rises through the outlet line 34 via the riser pipe 36, is blown directly onto the temperature sensor 38.

The air, which still partially carries oil particles, is then conducted via the holder 40 into the air deoiling element 42 and, if the corresponding minimum pressure is attained, passes into the air outlet line 51.

The oil 22 situated in the housing 20 is kept at operating temperature via the oil filter 62 and possibly via the heat exchanger 74.

If no cooling is necessary, the heat exchanger 74 is not used and is also not activated.

The corresponding activation is performed by the thermostat valve 66. After purification in the oil filter 62, oil is fed via the line 68 to the screw 18 or to the screw 16, and also to the bearing 70. The screw 16 or the screw 18 is supplied with oil 22 via the return line 52, 58, and the purification of the oil 22 takes place here in the air deoiling element 42.

By means of the electric motor (not shown in any more detail), which transmits its torque via the shaft 14 to the screw 16, which in turn meshes with the screw 18, the screws 16 and 18 of the screw compressor 10 are driven.

By means of the relief valve 80 (not shown in any more detail), it is ensured that the high pressure that prevails for example at the outlet side of the screws 16, 18 in the operational state cannot be enclosed in the region of the feed line 32, and that, instead, in particular during the start-up of the compressor, there is always a low inlet pressure, in particular atmospheric pressure, prevailing in the region of the feed line 32. Otherwise, upon a start-up of the compressor, a very high pressure would initially be generated at the outlet side of the screws 16 and 18, which would overload the drive motor.

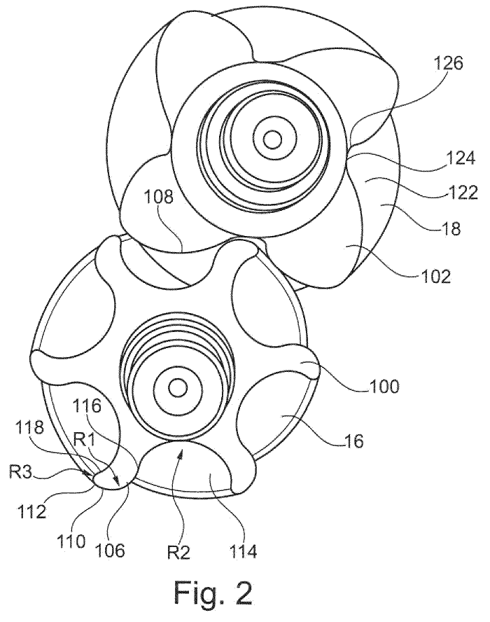

FIG. 2 shows, in a frontal illustration, the intermeshing female screw 16 and the male screw 18.

As can be clearly seen from FIG. 2, the female screw 16 has six screw teeth 100 which are of identical construction and which are distributed uniformly over the circumference.

By contrast, the male screw 18 has four screw teeth 102, which are likewise distributed uniformly over the circumference.

The number of teeth 100 of the female screw 16 is thus greater than that of the male screw 18.

By means of such a design, a transmission ratio of female screw 16 to male screw 18 of 3:2 is formed.

The female screw 16 and the male screw 18 have substantially the same nominal diameter.

As can also be seen from FIG. 2, the teeth 100 of the female screw 16 each have a rolling tooth flank 106, which is provided for rolling on the tooth flank 108 of the male screw 18.

The rolling tooth flank 106 has, in its tip region 110, a convexly rounded rolling tip region 112, which has a first radius R1.

Furthermore, between two adjacent teeth 100 of the female screw 16, there is provided a tooth base 114 which has a second radius R2.

Here, the second radius R2 is 2.5 times to 3.5 times greater than the first radius R1, in this case 3 times greater than the first radius R1.

The rolling tip region 112 and the tooth base 114 transition into one another via a flat transition region 116. A near-infinite radius, that is to say a complete flattening, is provided in the transition region 116.

The teeth 100 of the female screw 16 have a setting-down flank 118 on the side averted from the rolling tooth flank 106, which setting-down flanks serve for the setting-down onto the teeth 102 of the male screw 18.

The setting-down flank 118 transitions from the rolling tip region 112 by means of a tip region 110 with a third radius R3 into one another.

Here, the third radius R3 is smaller than the first radius R1, specifically in this case 3 times smaller than the first radius R1.

The ratio of radius R3 to radius R1 may lie in the range between 2.5 times to 3.5 times smaller than the first radius R1 for the value of radius R3.

The tip region 110 itself transitions directly, without an intermediate region, into the tooth base 114 of the female screw 16.

With regard to FIG. 2, it is basically to be noted that the teeth 100 of the female screw 16 are formed in the manner of turbine blades.

The teeth 102 of the male screw 18 likewise have a tooth base 122, at the lowest point 124 of which there is provided a kink 126.

Here, the kink 126 is of rounded form and serves for the engagement with the rolling tip region 112 in the tip region 110 of the teeth 100 of the female screw 16.

Here, the kink 126 has a substantially obtuse angle.

Here, the angle may be configured in the range between 90° and approximately 110°.

### LIST OF REFERENCE SIGNS

10 Screw compressor
12 Fastening flange
14 Input shaft
16 Screws
18 Screws
20 Housing
22 Oil
24 Inlet connector
26 Air filter
28 Air inlet
30 Valve insert
32 Air feed channel
34 Air outlet pipe
36 Riser line
38 Temperature sensor
40 Holder for an air deoiling element
42 Air deoiling element
44 Filter screen or known filter or oil separation devices
46 Air outlet opening
48 Check valve
50 Minimum pressure valve
51 Air outlet
52 Riser line
54 Filter and check valve
56 Nozzle
58 Oil return line
59 Oil drain screw
60 Attachment piece
60a Outer ring
60b Inner ring
62 Oil filter
64 Oil filter inlet channel
66 Thermostat valve
68 Return line
70 Bearing
72 Nozzle
74 Cooler, heat exchanger
76 Safety valve
78 Bypass line
80 Relief valve
82 Oil level sensor
100 Screw teeth
102 Screw teeth
106 Rolling flank
108 Tooth flank
110 Tip region
112 Rolling tip region
114 Tooth base
116 Transition region
118 Setting-down flank
122 Tooth base
124 Lowest point
126 Kink
R1 First radius
R2 Second radius
R3 Third radius

1-10. (canceled)

11. An arrangement of screws for a screw compressor for a utility vehicle, comprising:
at least one female screw; and
at least one male screw, wherein
the female screw and the male screw each have teeth which mesh with one another, the teeth of the female screw have a rolling tooth flank which is provided for rolling on a tooth flank of the male screw,
the rolling tooth flank has, in a tip region, a convexly rounded rolling tip region which has a first radius,
between two adjacent teeth of the female screw, a tooth base is provided which is connected via a flat transition region to the rolling tip region, and
the tooth base between the two adjacent teeth of the female screw is substantially concavely rounded with at least a second radius, wherein the second radius is approximately 2.5 to 3.5 times greater than the first radius.

12. The arrangement of screws for a screw compressor as claimed in claim 11, wherein
the number of teeth of the female screw is greater than that of the male screw.

13. The arrangement of screws for a screw compressor as claimed in claim 12, wherein
a transmission ratio of the female screw to the male screw is three to two.

14. The arrangement of screws for a screw compressor as claimed in claim 13, wherein
the female screw has six teeth and the male screw has four teeth.

15. The arrangement of screws for a screw compressor as claimed in claim 11, wherein
the female screw and the male screw have substantially the same nominal diameter.

16. The arrangement of screws for a screw compressor as claimed in claim 11, wherein
the teeth of the female screw have on the side averted from the rolling tooth flank, a setting-down flank for setting-down onto the teeth of the male screw, and
the setting-down flank transitions from the rolling tip region by way of a tip region with a third radius which is smaller than the first radius.

17. The arrangement of screws for a screw compressor as claimed in claim 16, wherein
the third radius is approximately 2.5 to 3.5 times smaller than the first radius.

18. The arrangement of screws for a screw compressor as claimed in claim 16, wherein
the tip region transitions directly, without an intermediate region, into the tooth base.

19. The arrangement of screws for a screw compressor as claimed in claim 11, wherein
the teeth of the female screw are formed in the manner of turbine blades.

20. The arrangement of screws for a screw compressor as claimed in claim 16, wherein
the teeth of the male screw have a tooth base, at a lowest point of which there is provided a rounded kink, wherein the lowest point of the kink is provided for engagement with the rolling tip region and the tip region.

21. The arrangement of screws for a screw compressor as claimed in claim 20, wherein
the kink substantially encloses an angle between approximately 90° and approximately 110°.
